(19) United States
(12) Patent Application Publication
(10) Pub. No.: US 2024/0408598 A1
(43) Pub. Date: Dec. 12, 2024

(54) LIQUID TRANSFER BETWEEN ROTATING MODULES

(71) Applicant: Hahn-Schickard-Gesellschaft für angewandte Forschung e.V., Villingen-Schwenningen (DE)

(72) Inventors: Peter JÜLG, Freiburg (DE); Yumi KAKU, Freiburg (DE); Moritz BÖSENBERG, Freiburg (DE); Nils PAUST, Freiburg (DE); Tobias HUTZENLAUB, Ettenheim (DE); Jan LÜDDECKE, 79395 (DE)

(73) Assignee: Hahn-Schickard-Gesellschaft für angewandte Forschung e.V., Villingen-Schwenningen (DE)

(21) Appl. No.: 18/813,056

(22) Filed: Aug. 23, 2024

Related U.S. Application Data
(63) Continuation of application No. PCT/EP2023/052953, filed on Feb. 7, 2023.

(30) Foreign Application Priority Data
Feb. 24, 2022 (DE) 102022201938.5

(51) Int. Cl. B01L 3/00; B01L 3/02

(52) U.S. Cl. CPC B01L 3/50273; B01L 3/021; B01L 3/5025; B01L 2200/025; B01L 2200/14; B01L 2400/0409; B01L 2400/0475

(57) ABSTRACT

An apparatus for transferring liquid between a fluid module rotating around a rotation axis and a transfer module rotating around the rotation axis comprises a first drive effecting rotation of the fluidic module to move a fluid opening of the fluidic module oriented in a first direction along a circular path around the rotation axis. The second drive rotates the transfer module to move a transfer opening of the transfer module oriented in a second axial direction with respect to the rotation axis along a circular path around the rotation axis. The first direction and second direction correspond to axial directions opposite to each other. The rotation of the fluidic module and the rotation of the transfer module are synchronized to position the fluid opening and the transfer opening relative to each other to allow liquid transfer between the transfer opening and the fluid opening during the rotations.

### CROSS-REFERENCE TO RELATED APPLICATIONS

This application is a continuation of copending International Application No. PCT/EP2023/052953, filed Feb. 7, 2023, which is incorporated herein by reference in its entirety, and additionally claims priority from German Application No. 102022201938.5, filed Feb. 24, 2022, which is also incorporated herein by reference in its entirety.

The present invention relates to apparatuses and methods for transferring liquid between modules, while the modules each rotate around a rotation axis such that a fluid opening of the fluidic module moves along a circular path around the rotation axis and a transfer opening of the transfer module also moves along a circular path around the rotation axis.

### BACKGROUND OF THE INVENTION

Centrifugal microfluidics deals with handling liquids in the picoliter to milliliter range in rotating systems. Such systems are frequently disposable polymer cartridges used in or instead of centrifugal rotors with the intent of automating laboratory processes. Here, standard laboratory processes, such as pipetting, centrifuging, mixing or aliquoting can be implemented in a microfluidic cartridge. For that purpose, the cartridges include channels for fluid guidance, as well as chambers for collecting liquids. Generally, structures configured for handling fluids can be referred to as fluidic structures. Generally, such cartridges can be referred to as fluidic modules.

New fields of application, such as liquid biopsies or process monitoring can need larger sample volumes than before, wherein, normally, needed reagents scale together with the sample volume. Here, microfluidic platforms or cartridges can reach their throughput or capacity limits. Centrifugal microfluidic platforms are known, on which samples of a maximum of a few 100 μl can be processed. Such microfluidic cartridges are described, for example, in O. Strohmeier et al., Chem. Soc. Rev. 44, 6187 (2015). Additionally, for novel applications, such as methylation pattern analysis in cell-free DNA by means of sequencing (cfMeDIP-seq method, see S. Y. Shen et al., Nat. Protoc. 7, 617-636 (2012)) the number of reagents increases due to the complexity of the methods. The same cannot be realized on typical microfluidic platforms or cartridges. Further, some reagents have to be freshly prepared and can therefore not be prestored in the microfluidic cartridge. Further, many of the needed reagents have wetting characteristics and it can therefore happen that the liquids are distributed in the system by capillary forces immediately after pipetting and therefore cause problems in the subsequent microfluidic protocol (e.g. by closing vents or filling of transfer syphons).

From conventional technology, basically, several systems are known for filling centrifugal microfluidic cartridges or comparable test carriers at standstill. Thereby, liquid is dispensed into a fluid opening of the cartridge by the dispenser that is also at standstill, wherein subsequently the centrifugal microfluidic cartridge is rotated to use this liquid in any form. Here, reference can be made, for example, to J. Steigert et al., “Direct hemoglobin measurement on a centrifugal microfluidic platform for point-of-care diagnostics”, Sensors and Actuators, A: PHYSICAL 130-131, pages 228-233, 2006. A similar method is also described in US 2022/0008924 A1.

Further, in conventional technology, systems are known for filling centrifugal microfluidic cartridges under rotation of the centrifugal microfluidic cartridge. In such systems, the dispenser is located at a fixed position. Thus, for example, M. Karle et al., “Axial Centrifugal Filtration—A Novel Approach for Rapid Bacterial Concentration from a Large Volume”, Transducers and Eurosensors XXVII, The 17th International Conference on Solid-State Sensors, Actuators and Microsystems, pages 1235-1238, IEEE, Piscataway, NJ, 2013, disclose a method where a liquid is introduced into an inlet located on a center of rotation, while the dispenser is located at a fixed position. A similar method is also described in A. P. Bouchard et al., “Non-contact Addition, Metering, and Distribution of Liquids into Centrifugal Microfluidic Devices in Motion”, Analytical Chemistry 82, pages 8386-8389, 2010, wherein a continuous liquid flow is introduced in a centrally arranged inlet opening of a rotating platform. A similar method is also described in US 2022/0008924 A1. In S. Haeberle et al., “Centrifugal Micromixer”, Chem. Eng. Technol. 28, pages 613-616, 2005, a method is described, where several annular inlet chambers are arranged on a rotating platform, which are filled during a rotation by quasi continuous liquid flow.

From U.S. Pat. No. 7,935,522 B2, apparatuses and methods are known where addition of a liquid is provided via a piezoelectric dispensing apparatus, wherein the dispensing of liquid drops from the apparatus is synchronized with the rotating speed of the disc. DE 10 2016 213 00 A1 discloses a centrifugal microfluidic cartridge wherein charging charge fluidic structures with a sample can take place at standstill or in rotation, for example, by introducing, dripping or pipetting.

Methods and apparatuses where liquid or liquid drops are transferred from a dispensing unit to a receiving unit that are subject to a common rotation are known, for example, from EP 3 815 788 A1, US 2003/0 032 071 A1, US 2014/0 106 395 A1, US 2015/0 196 907 A1, US 2019/0 293 598 A1 and US 2015/0 273 469 A1.

In new fields of application, such as liquid biopsy, samples of one milliliter or more may be needed, where it would be advantageous to be able to supply samples continuously during preparation steps or during analysis.

### SUMMARY

According to an embodiment, an apparatus for transferring liquid between modules rotating around a rotation axis may have: a fluidic module having a fluid opening oriented in a first direction and fluidically connected to fluidic structures in the fluidic module, wherein the first direction corresponds to a first axial direction with respect to the rotation axis or has an angle of <90° to the first axial direction; a transfer module having a transfer opening oriented in a second direction, wherein the second direction corresponds to a second axial direction with respect to the rotation axis that is opposite to the first axial direction or has an angle of <90° to the second axial direction, wherein the transfer module is configured to dispense or receive liquid through the transfer opening; a first drive configured to effect a rotation of the fluidic module to move the fluid opening along a circular path around the rotation axis; a second drive configured to effect a rotation of the transfer module to move the transfer opening along a circular path around the rotation axis; and a control configured to synchronize the rotation of the fluidic module and the rotation of the transfer module to position the fluid opening and the transfer opening relative to each other to allow liquid transfer between the transfer opening and the fluid opening during the rotations.

According to another embodiment, a method for transferring liquid between modules rotating around a rotation axis may have the steps of: effecting a rotation of a fluidic module having a fluid opening oriented in a first direction and fluidically connected to fluidic structures in the fluidic module to move the fluid opening along a circular path around the rotation axis, wherein the first direction corresponds to a first axial direction with respect to the rotation axis or has an angle of <90° to the first axial direction; effecting a rotation of a transfer module having a transfer opening oriented in a second direction, wherein the second direction corresponds to a second axial direction with respect to the rotation axis that is opposite to the first axial direction or has an angle of <90° to the second axial direction, wherein the transfer module is configured to dispense or receive liquid through the transfer opening, to move the transfer opening along a circular path around the rotation axis; synchronizing the rotation of the fluidic module and the rotation of the transfer module to position the fluid opening and the transfer opening relative to each other; and effecting a liquid transfer between the transfer opening and the fluid opening while the rotations of the fluidic modules and the transfer modules are synchronized with each other.

Examples of the present invention provide an apparatus for transferring liquid between modules rotating around a rotation axis, comprising:
a fluidic module comprising a fluid opening oriented in a first direction and fluidically connected to fluidic structures in the fluidic module, wherein the first direction corresponds to a first axial direction with respect to the rotation axis or comprises an angle of <90° to the first axial direction;
a transfer module comprising a transfer opening oriented in a second direction, wherein the second direction corresponds to a second axial direction with respect to the rotation axis that is opposite to the first axial direction or comprises an angle of <90° to the second axial direction, wherein the transfer module is configured to dispense or receive liquid through the transfer opening;
a first drive configured to effect a rotation of the fluidic module to move the fluid opening along a circular path around the rotation axis;
a second drive configured to effect a rotation of the transfer module to move the transfer opening along a circular path around the rotation axis; and
a control configured to synchronize the rotation of the fluidic module and the rotation of the transfer module to position the fluid opening and the transfer opening relative to each other to allow liquid transfer between the transfer opening and the fluid opening during the rotations.

Examples of the present invention provide a method for transferring liquid between modules rotating around a rotation axis, comprising:
effecting a rotation of a fluidic module comprising a fluid opening oriented in a first direction and fluidically connected to fluidic structures in the fluidic module to move the fluid opening along a circular path around the rotation axis, wherein the first direction corresponds to a first axial direction with respect to the rotation axis or comprises an angle of <90° to the first axial direction;
effecting a rotation of a transfer module comprising a transfer opening oriented in a second axial direction with respect to the rotation axis that is opposite to the first axial direction, wherein the second direction corresponds to a second axial direction with respect to the rotation axis that is opposite to the first axial direction or comprises an angle of <90° to the second axial direction, wherein the transfer module is configured to dispense or receive liquid through the transfer opening, to move the transfer opening along a circular path around the rotation axis;
synchronizing the rotation of the fluidic module and the rotation of the transfer module to position the fluid opening and the transfer opening relative to each other; and
effecting a liquid transfer between the transfer opening and the fluid opening while the rotations of the fluidic modules and the transfer modules are synchronized with each other.

According to the invention, the fluidic module is driven by a first drive and the transfer module is driven by a second drive. The first drive and the second drive can be controlled independently of each other. To allow liquid transfer during the rotations of the fluidic module and the transfer module effected by the drives, the rotations are synchronized by the control, such that the fluid opening and the transfer opening are positioned to each other, i.e., aligned with each other to allow liquid transfer between the same during the rotations. Thereby, it is possible the effect a liquid transfer between fluidic module and transfer module in a flexible manner, while both modules are rotating, such that liquid can be transferred in the preparation of an analysis, during an analysis or after an analysis, while the modules are rotating, i.e., without having to stop the same.

Here, in examples, during the rotation of the fluidic module and the rotation of the transfer module, liquid can be dispensed or received through the transfer opening. Here, the transfer module can be configured to eject liquid out of the transfer opening continuously as a jet or discontinuously as drops. Here, due to synchronization, the fluid opening and the transfer opening are aligned with each other to allow liquid from the transfer opening to reach the fluid opening. In examples, the fluid opening and the transfer opening can be positioned relative to each other in azimuth direction with respect to the rotation axis (isoradial), i.e., in an offset manner to compensate an offset of the trajectory on the free path between transfer openings and fluid openings. In examples, the circular path along which the fluid opening moves and the circular path along which the transfer opening moves can have an identical radius. In embodiments, the circular path along which the transfer opening moves can have a slightly smaller radius than the circular path along which the fluid opening moves in order to compensate a centrifugal deflection of the liquid on the free path between the transfer opening and the fluid opening. Thus, examples of the invention can be configured to realize a safe or secure transfer of liquids between transfer opening and fluid opening.

In examples, the transfer module can comprise an electronic pipette having a pipette tip, wherein the transfer opening is formed on the pipette tip. Thus, examples of the invention can be configured to draw liquid from the fluidic module while the fluidic module is rotating. For this purpose, in examples, a maneuvering means can be provided that is configured to move the pipette tip and/or the fluidic module in the first or the second direction during the synchronous rotation of fluidic module and transfer module, for example, in axial direction with respect to the rotation axis, to dip the pipette tip into the fluid opening. Thus, during the rotations, liquid can be drawn from the fluid opening by means of the pipette tip.

In examples, the fluidic module can comprise several fluid openings, wherein the rotation of the fluidic module and the rotation of the transfer module can be synchronized subsequently to position one of the several fluid openings and the transfer opening in relation to each other, to allow liquid transfer between the transfer opening and the respective fluid opening. In examples, the transfer module can comprise several transfer openings, wherein the rotation of the fluidic module and the rotation of the transfer module can be synchronized to position the several transport openings and several fluid openings relative to each other to allow liquid transfer between the transfer openings and the fluid openings. Thereby, liquid transfer can be effected between several fluid openings and the transfer opening. In examples, the radial position of the transfer opening can be adjusted to effect a radial alignment of the transfer opening with the fluid opening or to successively effect an alignment of the transfer opening with a respective one of several fluid openings located at different radial positions.

In embodiments, the first drive is a centrifugal rotor or a rotating motor. In examples, the second drive comprises a rotating motor, a robot arm having several axes or a linear axis system. Thus, examples of the invention allow a combination of robotics for dispensing liquid during an analysis or a sample preparation step and a centrifugal microfluidic cartridge on which a process chain is performed, such that higher sample volumes can be processed. Thus, examples of the invention are directed to a combination of robotics and microfluidic platforms, which allows the automation of laboratory processes in the context of biological process chains in an advantageous and flexible manner.

In examples, the control is configured to control the first or second drive to effect a rotation of the fluidic module at a rotation frequency corresponding to the rotation frequency of the transfer module or to effect a rotation of the transfer module at a rotation frequency corresponding to the rotation frequency of the fluidic module. Here, the control can be configured to detect an angular offset between the fluid opening and the transfer opening as to control the rotation of the fluidic module and/or the transfer module to bring the angular offset into a tolerance range. In examples, the control can be configured to detect the angular offset based on a difference between an actual position of the fluid opening (or the transfer opening) and target position when the transfer opening (or the fluid opening) is located a specific position along the respective circular path. Thus, examples of the invention allow synchronization of the rotations of fluidic modules and transfer modules in a simple manner.

In examples, the first direction into which the transfer opening is oriented, is the first axial direction with respect to the rotation axis and the second direction into which the fluid opening is oriented, is the second axial direction opposite to the first axial direction with respect to the rotation axis. In examples, the transfer opening(s) and/or the fluidic opening(s) can be oriented in a direction comprising an angle less than 90°, less than 60°, less than 45° or less than 30° with respect to the rotation axis.

### BRIEF DESCRIPTION OF THE DRAWINGS

Embodiments of the present invention will be detailed subsequently referring to the appended drawings, in which:

FIG. 1 shows a schematic illustration of an apparatus for transferring liquid according to an example of the present invention;

FIG. 2 shows a schematic illustration of an example of an apparatus for transferring liquid according to the present invention;

FIG. 3 shows a flow diagram of an example of a method according to the present invention;

FIG. 4 shows a schematic illustration of an example of a second drive comprising a robot arm operating according to the so-called SCARA principle;

FIG. 5 shows a schematic illustration of an example of a second drive comprising a linear axis system;

FIG. 6 shows a schematic illustration of a second drive comprising a combination of linear axis system and rotation system;

FIG. 7 shows a flow diagram of an example of a method according to the present invention;

FIG. 8 shows a flow diagram of an example of a method for synchronizing the rotations; and

FIG. 9 shows a schematic illustration of an angular offset and a rotor frequency diagram for explaining the synchronization of FIG. 8.

### DETAILED DESCRIPTION OF THE INVENTION

In the following, examples of the present disclosure will be described in more detail and by using the accompanying drawings. It should be noted that the same elements or elements having the same functionality are provided with the same or similar reference numbers, wherein a repeated description of elements provided with the same or similar reference numbers is typically omitted. Descriptions of elements having the same or similar reference numbers can be interchangeable. In the following description, many details will be described to provide a thorough explanation of examples of the disclosure. However, it is obvious for people skilled in the art that other examples can be implemented without these specific details. Features of the different described examples can be combined, except features of a respective combination exclude each other or such a combination is explicitly excluded.

Examples of the present invention relate to apparatuses and methods for providing liquids into a microfluidic module under rotation in a time and location defined manner. For that purpose, a transfer module, such as a system for dispensing liquids, such as an electronic pipette or a dispenser (e.g. piezoelectric pump, syringe pump, pneumatic pump or peristaltic pump) or its outlet (e.g. a nozzle or an end of a tube) is put in rotation to transfer liquid into a second rotating fluidic system. Dispensing takes place under synchronization of the rotational movement of both systems, both with regard to the rotational frequency as well as with regard to the radial and isoradial position of dispensing point and receiving point of the liquid. The dispensing point can be the transfer opening, for example, in a pipette tip, and the receiving point can be the fluid opening, for example, an inlet into a microfluidic module. Here, the aim is a time and location defined provision of liquids, for example washing buffers, which are needed for performing processes, for example purification of a biological sample. In that way, in particular processes having large volumes, both of the sample and of reagents can be realized with small space requirements. In contrary to previous methods, either performing filling at standstill of the fluidic module with interfering capillary forces or using triggered drop dispensing and hence, a lower volume flow, according to the invention, larger amounts of liquid can be transferred into the fluidic module or can be drawn from the fluidic module in a safer manner and in less time. A further advantage is the programmable volume of dispensing liquid. Apart from a very large range of volumes of the microliter up to the milliliter range, the volume can be determined and dispensed in dependence on the running process, for example by means of an optical measurement of a concentration of a mixture in the fluidic module obtained by the addition of liquid. Thus, examples of the invention provide the option of online process control. In examples, the method can also be used in reverse direction to draw liquids from the rotating fluidic module, for example a finished product obtained by a process chain. In summary, examples of the invention provide a new operation for supplying fluidic modules with arbitrary volumes of one or several different liquids or for withdrawing the same at any time and at any location in the form of inlet chambers at different positions on the fluidic module.

Thus, examples of the invention allow overcoming disadvantages occurring in known methods. Thus, according to the invention, it is not needed to perform transfer of media into or out of the fluidic module at standstill, such that interfering capillary forces play a lesser or no role according to the invention. In examples of the invention, no functionalization of surfaces of the fluidic module, for example hydrophobization is needed. Examples of the invention involve no introduction of large containers, which are still limited with regard to volume, such as flow bags, so-called stick packs. Examples of the invention allow large volume flows when transferring liquids into the fluidic module, which is not possible in known methods, for example, the discrete dispensing of drops by using trigger signals. Examples of the invention allow electronic programming and hence online process control, for example also by adapting the transfer volumes. In contrary to known methods, examples of the invention are also suitable for withdrawing liquid products from the fluidic module under rotation.

Before examples of the present invention will be explained in more detail, definitions of some terms used herein will be given.

Here, a rotating module means a module performing a circular movement in a defined plane and around defined center of rotation. In examples, such a rotation can be effected by using a robot arm, and axis system or rotating motor.

Here, a transfer module means an apparatus for precise and time-controlled dispensing or receiving of liquids or other substances or mixtures of substances. Examples of apparatuses for precise and time-controlled dispensing of liquids are, for example, dispensers, pumps or pipettes that can be mounted, for example on a gripper. The transfer module can represent a rotating module or can be mounted on a rotating module and hence follow its circular movement. The transfer module transfers liquid, samples and/or reagents into the fluidic module and possibly products out of the fluidic module. In examples, the transfer module can be located above the fluidic module and can hence be referred to as upper rotating module.

Here, a fluidic module means an apparatus for performing fluidic and/or biochemical processes under rotation. Here, apart from the fluidic opening, the fluidic module can include further fluidic structures, such as channels and chambers. Here, the fluidic module can include microstructures and/or microscopic structures. In examples, the fluidic module can be configured in the form of a centrifugal microfluidic chip. In examples, the fluidic module can comprise macroscopic structures, for example in the form of a microliter plate or in the form of microreaction vessels. In examples, the fluidic modules can comprise a fluid chamber in addition to the fluid opening, and can be configured as a microreaction vessel in a simple case. The fluidic module can represent a rotating module or can be connected to a rotating module and hence follow its circular movement. In examples, the fluidic module can be located below the transfer module and can hence be referred to as bottom rotating module.

Here, regulation means a method synchronizing the two rotating modules based on real time measurement data. Here, both the transfer module can be regulated to the movement of the fluidic module as well as vice versa as well as both at the same time. A further function of the regulation can be the control of the transfer module as soon as the synchronization of the rotational movements is within a predetermined tolerance window.

In this context, a sample is a liquid or a liquid mixture of substances which can be analyzed completely or partly within the fluidic module or can be prepared within the same for subsequent analysis, for example DNA extraction. Examples of such samples are blood samples, water samples, process samples, liquefied skin samples, liquefied insect samples, etc. In this context, reagents are all, in particular liquid, substances and mixtures of substances, which are needed for analysis or preparation of the sample, for example, washing buffers, acids, dilutions, nanoparticles and the same. In this context, a product is a result or intermediate result of a process in the rotating fluidic module, for example, purified DNA.

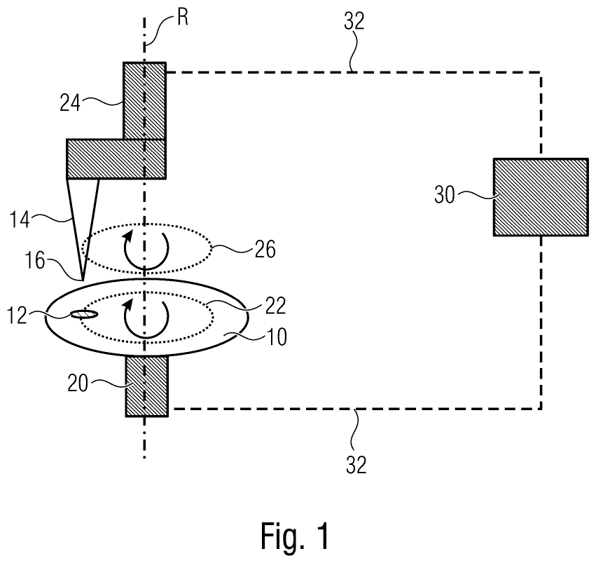

FIG. 1 shows schematically an example of an apparatus for transferring liquid between modules rotating around a rotation axis. The apparatus comprises a fluidic module 10 in the form of a rotation body, here also referred to as rotor. In other examples, the fluidic module can be insertable into a rotation body. The fluidic module 10 comprises a fluid opening 12, which is oriented in a first axial direction with respect to a rotation axis R. The fluid opening 12 is fluidically connected to fluidic structures in the fluidic module 10, for example one or several fluid chambers and/or fluid channels (not shown). In the shown example, the first axial direction with respect to the rotation axis R is towards the top. The apparatus comprises a transfer module 14 comprising a transfer opening 16 formed, for example at a bottom end of the transfer module 14. In examples, the transfer module 14 can be formed by an electronic pipette, wherein the transfer opening 16 is formed by an opening at the pipette tip. The transfer opening is oriented in a second axial rotation with respect to the rotation axis R, in the example shown towards the bottom. Thus, the fluid opening and the transfer opening are facing each other.

The apparatus comprises a first drive 20 that is configured to effect a rotational movement, rotation, of the fluidic module 10 around the rotation axis R in order to move the fluid opening 12 along a circular path 22 around the rotation axis R. In examples, the first drive 20 can be formed by a centrifuge or a rotational motor, for example, a stepper motor or a servo motor. The first drive 20 can be configured to effect a precise and time-controlled realization of the circular movement of the fluid opening 12 in a defined plane perpendicular to the rotation axis R and around a defined center of rotation, the rotation axis R. In examples, the first drive can be mounted on a linear axis. Thus, the first drive can serve as maneuvering means by which the fluid opening is traversed along the rotation axis R in the direction of the transfer opening. Thus, by the electronic pipette, liquid can be transferred between the fluid opening and the transfer opening in the direction from the fluid opening to the transfer opening.

The apparatus comprises a second drive 24 that is configured to effect a rotational movement of the transfer module 14 around the rotation axis R to move the transfer opening 16 along the circular path 26 around the rotation axis R. The circular path 26 can have the same radius as the circular path 22. In examples, the radius of the circular path 26 can be slightly smaller than the radius of the circular path 22 to compensate a centrifugal deflection of the liquid on the free path between the transfer opening 16 and the fluid opening 12. In examples, the second drive 24 can be configured by a rotating motor, on the rotor of which the transfer module 14 is mounted, to effect the rotation of the same. In examples, the transfer module 14 can be mounted on the first drive via a carrier element. The first drive is configured to effect a precise and time-controlled realization of a circular movement in a defined plane perpendicular to the rotation axis R and around defined center of rotation, the rotation axis R. In examples, the second drive can be formed by a rotating motor, a robot arm or an axis system.

The apparatus comprises a control 30 that is configured to synchronize the rotation of the fluidic module 10 and the rotation of the transfer module 14 to position the fluid opening 12 and the transfer opening 16 relative to each other to allow liquid transfer between the transfer opening 16 and the fluid opening 12 during the rotations. As it is obvious for people skilled in the art, the control can, for example comprise one or several respectively programmed computing means, one or several microprocessors and/or one or several application-specific integrated circuits. In examples, a control can be configured in a distributed manner, wherein parts of the control can be formed by a computer and other parts of the control by the microprocesses associated to the respective drives. The control can be configured to effect the methods described herein and to control the drives accordingly, either automatically or in response to manual input by a user. For that purpose, the control 30 is communicatively connected to the drives 20, 24, as shown by dotted lines 32 in FIG. 1.

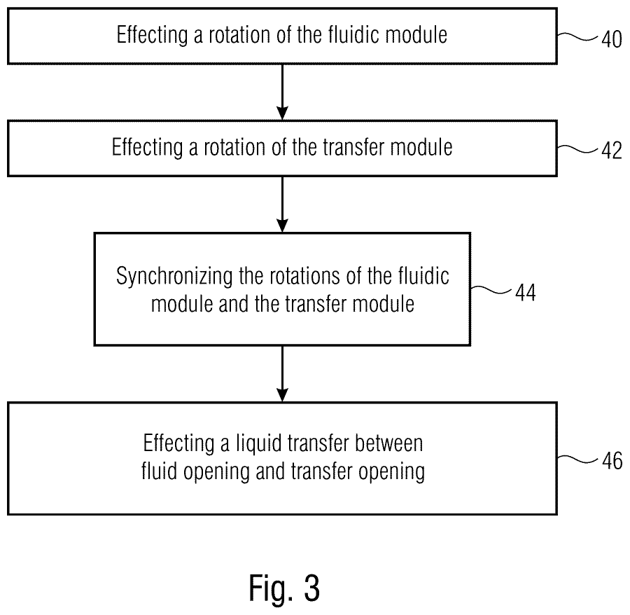

Examples of the apparatus are configured to perform a method as shown, for example, in FIG. 3. At 40, a rotation of the fluidic module 10 is effected to move the fluid opening 12 along the circular path 22. At 24, a rotation of the transfer module 14 is effected to move the transfer opening along the circular path 26. The rotations of the fluidic module and the transfer module are synchronized, 44, to position the fluid opening and the transfer opening relative to each other. As soon as the synchronization is reached, liquid transfer between the fluid opening and the transfer opening is effected, step 46 in FIG. 3.

In examples, first, the first drive 20 is started, such that the fluidic module 10 performs a circular movement. The second drive is started such that the transfer module 14 performs a second circular movement. By using the control 30, regulation is performed by which the two circular movements are synchronized, such that the transfer opening of the transfer module and the fluid opening of the fluidic module have a defined distance to each other in all spatial directions and maintain the same within a specified tolerance range. As soon as this synchronization is obtained, a transfer of substances or mixtures of substances from the transfer module 14 into the fluidic module 10 or from the fluidic module 10 into the transfer module 14 takes place. After the transfer is completed, for example, the circular movement of the transfer module can be stopped. At a later time, the circular movement of the transfer module can be started again to effect a transfer of further substances or mixtures of substances after a further synchronization.

There is no need for a separate explanation that real-time measurement data needed for regulation are provided or acquired. For that purpose, respective sensors can be provided for detecting the positions of the fluid opening and the transfer opening in an absolute or relative manner to each other. For example, rotary angle sensors can be provided to detect the respective angular position where the openings are located. Further, sensors can be provided to detect a radial position of the transfer opening and/or radial position of the fluid opening relative to the rotation axis R. The real-time measurement data detected in that manner can be provided to the control 30 via communication connection 32 in order to synchronize the rotations based thereon.

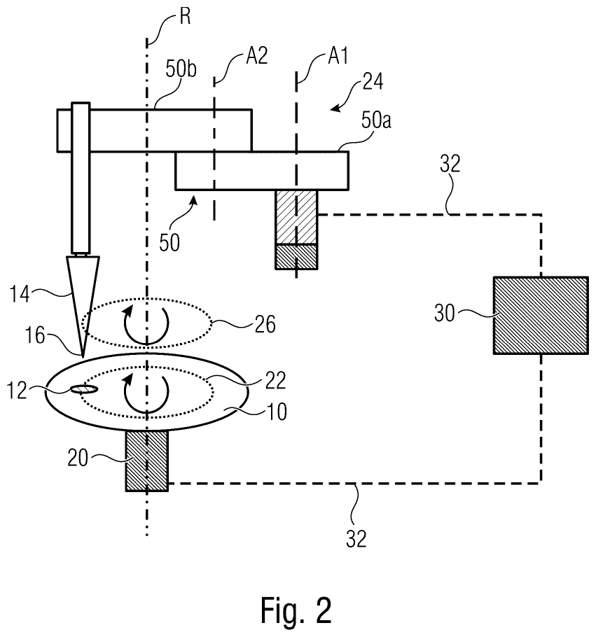

In examples of the present invention, the second drive can comprise a robot arm with several axes at the end of which an electronic pipette is located. FIG. 2 shows merely schematically an example where the second drive 24 comprises a robot arm with several arm portions 50a and 50b, wherein arm portion 50a is rotatable around an axis A1 and arm portion 50b around an axis A2 relative to the arm portion 50a. By a respective control of the rotations of the arm portions around the respective axes, rotation of the transfer module 14 mounted on the end of the arm portion 50b spaced apart from the axis A2 can be effected, such that the transfer opening 16 moves along the circular path 26.

In examples, the second drive can comprise a robot arm having several joints and axes, at the end of which the transfer module is located, for example, in the form of an electronic pipette. In examples, the robot arm of the second drive can be formed by a robot arm having several axes, for example 5 axes of a so-called five axis robot arm. In such a multi-axes robot arm, a synchronized circular movement can be generated by superposition of several joint movements.

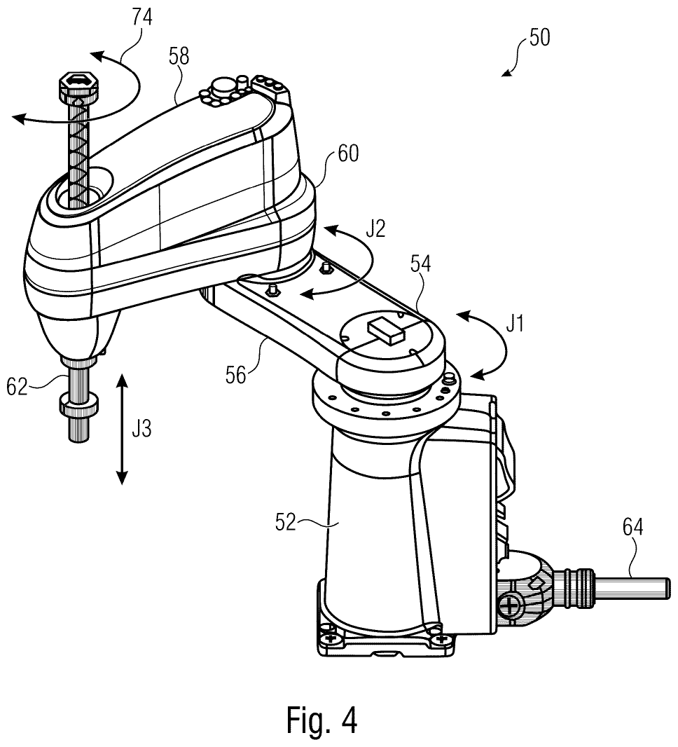

In examples, the second drive can comprise a robot arm of the type SCARA. An example of such a robot arm 50 is shown in FIG. 4. The robot arm comprises base 52, a shoulder joint 54, an inner connection part 56 and an outer connection part 58. The inner connection part 56 and the outer connection part 58 are connected via an elbow joint 60. A rotatable quill 62 is arranged at the end of the outer connection part 58 spaced apart from the elbow joint 60. An end of the inner connection part 56 is rotatable relative to the base 52 via the shoulder joint 54, see J1 in FIG. 4. The outer connection part 58 is rotatable relative to the inner connection part 56 via the elbow joint 60, J2 in FIG. 4. The quill 62 is rotatable around a rotation axis J4 in FIG. 4 and axially moveable relative to the rotating axis, J3 in FIG. 4. By respective control of the robot arm 50, for example wired via line 64, the movement of the transfer module 14 an be regulated by means of the control 30 to synchronize the movement of the transfer opening along the circular path with the movement of the fluid opening along the circular path. In a robot arm according to the SCARA principle, a synchronized circular movement can be generated by superposing several joint movements, in the example shown in FIG. 4 by a superposed movement J1, J2, of joints 54 and 60. The robot arm of the SCARA type shown I FIG. 4 can be used, for example, as robot arm 50 in FIG. 2. By a respective control of the joints of the robot arm, a radial position of the transfer module relative to the rotation axis around which the transfer module rotates can also be adjusted.

In examples, the transfer module can be mounted on the robot arm, for example, the quill 62 in the form of an electronic pipette. The robot arm can be controlled to move the pipette tip in axial direction with respect to the rotation axis. Thus, the robot arm can serve as a maneuvering means by which the pipette opening can be dipped into a fluid opening of a rotor and a liquid that is located in a fluid chamber adjacent to the fluid opening. Thus, by the electronic pipette, the liquid can be transferred between the fluid opening and the transfer opening in the direction from the fluid opening to the transfer opening.

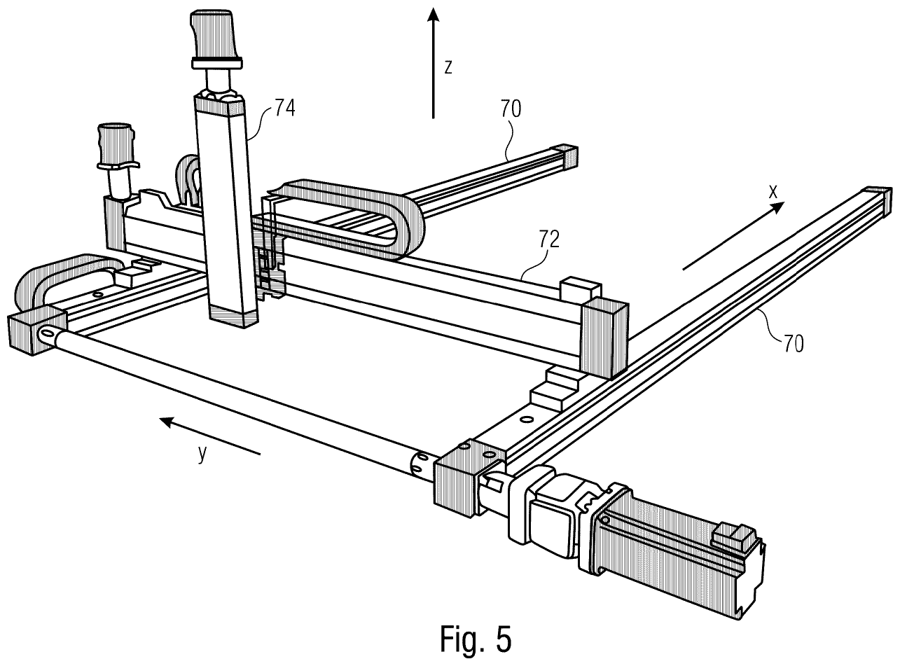

In examples, a linear axis system can be used to effect the rotation of the transfer module. An example of such a linear axis system is illustrated merely schematically in FIG. 5. The linear axis system comprises carrier bars 70, which allow movement of a crossbar 72 in a direction along a first linear axis x. The crossbar 72 allows movement of an end effector 74 in the direction of a second linear axis y. Thus, by traversing the crossbar 72 in the direction x and traversing the end effector 74 in the direction y, a circular movement of the end effector 74 can be effected. The transfer module 14 can be mounted or attached to the end effector 74, such that movement of the transfer opening of the transfer module along the circular path can be effected by a respective control. Thus, in the linear axis system, the synchronized rotational movement by a superposition of sine and cosine function in the course of movement of two orthogonally arranged linear axes (x, y) can be used to generate a circular movement resulting therefrom.

In examples, the transfer module can be mounted on the end effector 74 in the form of an electronic pipette. The end effector allows a movement of the transfer module in the direction of a third linear axis z. Thus, the end effector can be controlled to move the pipette tip in axial direction with respect to the rotation axis. Thus, the end effector can serve as maneuvering means by which the pipette opening can be dipped into a fluid opening of a rotor and a liquid located within a fluid chamber adjacent to the fluid opening. Thus, by the electronic pipette, liquid can be transferred between the fluid opening and the transfer opening in the direction from the fluid opening to the transfer opening.

In alternative examples, the second drive can comprise a rotating motor, for example, a step motor or servo motor, at the rotor of which the transfer module is mounted. In examples, a rotating motor can also be mounted on the end effector of a respective drive, for example the respective distant end of the arm portion 50b in FIG. 2, the outer connection part 58 in FIG. 4 or the end effector 74 in FIG. 5.

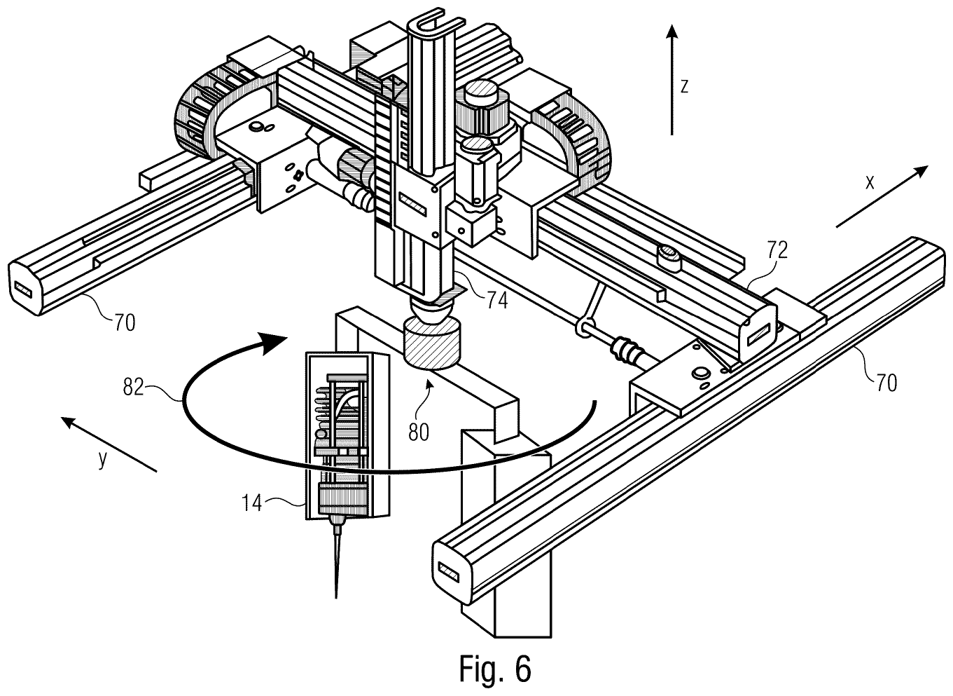

There is no need for a further explanation that any automation system can be used, which is suitable to effect a respective movement of the transfer module by which a rotation of the transfer opening along the circular path around the rotation axis can be effected. For example, FIG. 6 shows schematically the illustration of an automation system consisting of a combination of a liner axis system and a rotation system. Here, a rotation system 80 is mounted on the end effector 74 of a linear axis system by which a rotation of the transfer module 14 can be effected, as indicated by an arrow 82 in FIG. 6. Also in this example, the end effector allows a movement of the transfer module along the third linear axis z.

As can be seen from the above description, examples of the invention comprise a maneuvering means by which the transfer module and/or the fluidic module can be moved in a direction (first/second direction) to move the transfer module and the fluidic module towards each other and away from each other to thereby decrease and increase the distance between fluid opening(s) and transfer opening(s). Such a movement can be advantageous to allow receiving liquids from the fluidic module, for example a cannula, or dispensing liquid with a small distance between transfer module and fluidic module. In examples, the transfer module can be configured to effect a respective movement of the transfer opening as it can be the case in electronic pipettes comprising an integrated “z-axis”.

In examples, the transfer module can comprise an electronic pipette configured to receive and/or eject liquid through a pipette opening. Generally, an electronic pipette can herein mean a system that can be filled or discharged by an electronic signal, in contrary to manual operation in conventional pipettes. Such an electronic pipette is mounted on the end of a second drive (the upper rotating system) and connected to the control, either wired by means of a signal line or wireless. Thus, the electronic pipette can be operated by the control. The electronic pipette can include an integrated linear axis, which can move the pipette tip in an axial direction with respect to the rotation axis, in addition or instead of one of the above-described options. In alternative embodiments, the transfer module can comprise an electronic dispenser or pump or the outlet of a pump in the form of a tube, wherein liquid ejection can take place, for example, by means of a piezoactuator or in an electromagnetic manner. There is no need for a separate explanation that the transfer module can comprise any system that is suitable to eject or receive liquid through a transfer opening in an automated manner, for example by electronic control by means of the control described herein.

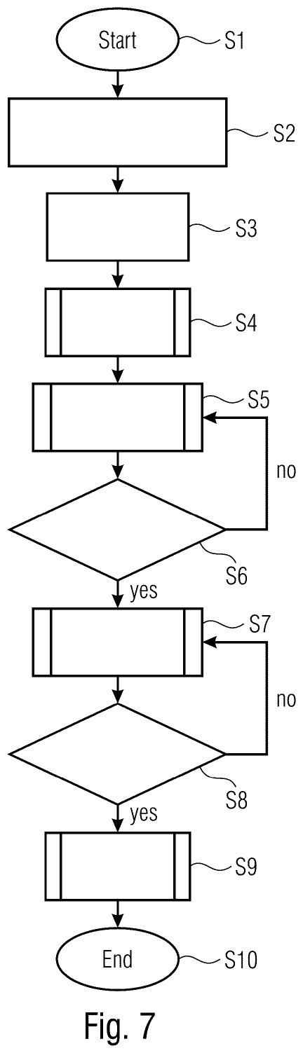

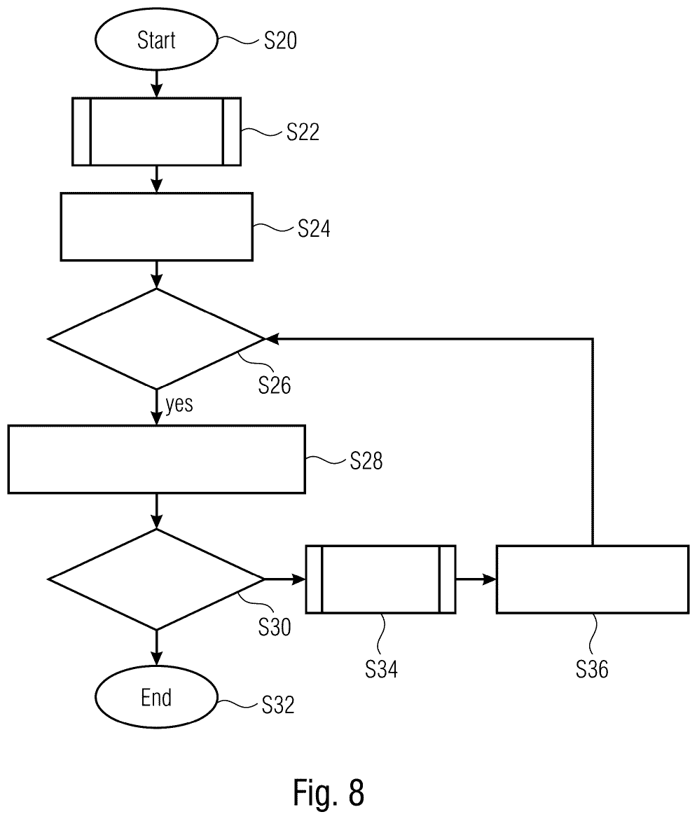

With reference to FIGS. 7 and 8, an example of a method for synchronizing the rotations of the fluidic module and the transfer module will be described. Thereby, it is assumed below that the fluidic module forms a rotor with the first drive and the second drive comprises a robot arm on which the transfer module is mounted. There is no need for a separate explanation that a respective method can also be implemented with all other fluidic modules, transfer modules, first drives and second drives described herein.

The method starts at S1. At S2, the position of the rotor is calibrated. In examples, for this, a microcontroller of the rotor can be adjusted to indicate an angular position of 0 when the rotor is at the null position. At S3, a target position where the fluid opening is to be located for the liquid transfer to effect a liquid transfer is set. This includes setting a target angular position of the rotor, as well as normally setting a radius with respect to the rotation axis. For example, a radius can be set at S3 when the rotor comprises several fluid openings at different radial positions of the same. If the axial position of the fluid opening can be set, e.g. by moving the rotor in the axial direction, setting the target position can also include setting an axial position of the fluid opening, wherein the method can then comprise setting the axial position of the fluid opening to the target position. Further, liquid that is to be transferred can be received in the transfer module, which can be an electronic pipette, if the electronic pipette has not been filled in advance. The zero-point calibration in step S2 can take place once at the beginning of the method, while step S3 is normally performed for every fluid transfer.

At S4, rotation of the robot arm representing the second drive is effected at a specific rotation frequency. The rotation frequency can, for example, be in a range of 3-10 Hz. Since the actual rotation frequency can deviate from the specific rotation frequency, in a step S5, the actual rotation frequency of the robot arm is measured and at S6, it is determined whether the measured rotation frequency of the robot arm is stable. If the rotation frequency is not stable, steps S5 and S6 will be repeated until the rotation frequency of the robot arm is stable. If it is determined in step S6 that the rotation frequency is stable, synchronization of the rotation of the rotor to the rotation of the robot arm is performed in step S7. Here, the rotor can already rotate (e.g. at higher rotation frequencies from a preceding process step) or can be set in rotation for the first time (e.g. when performing the first process step of an application protocol). In step S8, it is checked whether the synchronization was successful. If it is determined that the synchronization was not successful, steps S7 and S8 will be repeated. If it is determined in step S8 that the synchronization was successful, which shows that the transfer opening and the fluid opening are in the correct alignment with each other, the method jumps to step S9 where liquid is transferred between the transfer opening and the fluid opening. Subsequently, the method ends at S10.

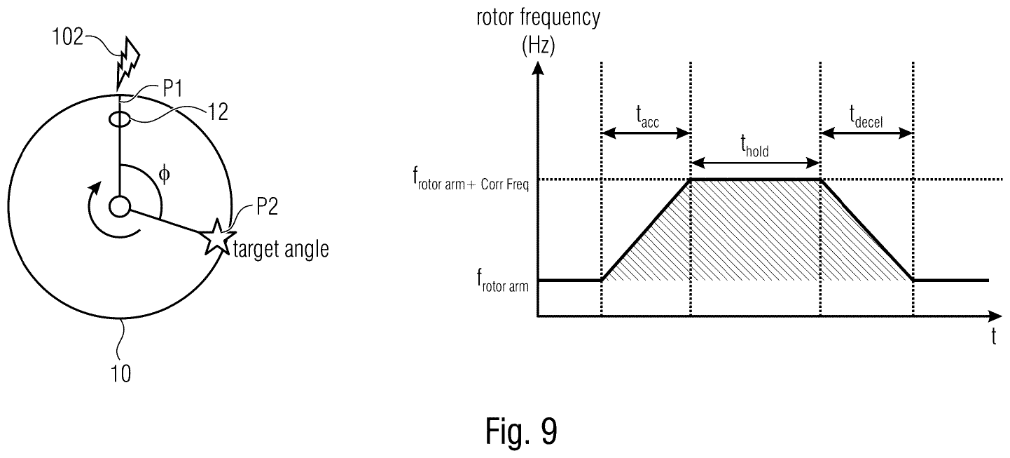

With reference to FIG. 8 and FIG. 9, an example will be described how the synchronization in steps S7 and S8 can take place. The method starts after step S6 in FIG. 7 where it has been determined that the rotation frequency of the robot arm is stable, S20 in FIG. 8. At S22, this stable rotation frequency of the robot arm is measured.

At S24, a rotation frequency of the rotor is set to the rotation frequency of the robot arm. At S26, it is determined whether a robot arm trigger has been detected. A robot arm trigger is triggered when a physical feature of the robot arm is at a specific angular position, such that the robot arm trigger indicates a predetermined angular position of the robot arm end effector on its circular path. In examples, a robot arm trigger can be triggered once per rotation of the end effector around 360°. Triggering the robot arm trigger is used as periodic position feedback to find out whether the end effector has reached a predetermined known position.

When it is detected in step S26 that the robot arm trigger has been triggered, the rotor angular position where the rotor is located at this time is set as current rotor angle position. In other words, the current rotor angle position is measured at the time when the robot arm trigger is triggered. Subsequently, in step S28, a difference between the target angle position and the current rotor angular position is determined. At S30, it is checked whether the amount of the calculated difference is within a predetermined tolerance range. If the amount of the calculated difference is within the tolerance range, the synchronization was successful and terminates at S32. Subsequently, the method jumps to step S9 in FIG. 7. If the calculated difference is not within the tolerance range at S30, correction parameters are determined that are used for controlling the first drive, i.e. the rotor to synchronize the rotation of the rotor with the rotation of the robot arm. For that purpose, at S34, a correction frequency and a correction time can be calculated by means of linear interpolation. At S36, the correction parameters are applied to the rotation of the rotor to reduce or at best to compensate the angular difference calculated at S30. Subsequently, the method jumps back to step S26, where upon steps S26 to S30 are repeated until it is determined in step S30 that the calculated difference is within the predetermined tolerance range. When this is the case, synchronization was successful and the method jumps to step S9 in FIG. 7. The predetermined tolerance range is determined such that when the angular difference is within the same, a liquid transfer between transfer opening and fluid opening is possible during the rotations of the transfer module and the fluidic module.

Regulation of the rotation of the rotor in order to synchronize the same with the rotation of the robot arm will be discussed again with reference to FIG. 9. FIG. 9 shows schematically a rotor 10 having a fluid opening 12 to which a liquid transfer is to take place. The fluid opening 12 is at a position P1 at a time of the robot arm trigger schematically shown at 102. The target angular position where the fluid opening 12 is to be located at the time when the robot arm trigger 102 occurs, is at P2. Thus, there is an angular offset Φ between the actually measured angle and the target angle. This angular offset is brought into the predetermined tolerance range by the described synchronization. For this purpose, as shown in FIG. 9, the rotor frequency could first be increased from the robot arm rotation frequency f_{robot arm} to an increased rotation frequency f_{robot arm}+corrFreq for an acceleration time t_{acc}, can be held at this increased frequency for a holding time t_{hold} and can then be lowered to the robot arm rotation frequency f_{robot arm} for a deceleration time t_{decel}. Thereby, a relative rotation between robot arm and rotor is effected by which the offset angle Φ between the transfer opening that rotates with the robot arm and the fluid opening that rotates with the rotor is compensated, such that the same are aligned with each other to allow liquid transfer between the same.

Although in the above-described example, the rotation of the fluidic module is controlled to be synchronized with the rotation of the transfer module, in other embodiments, the rotation of the transfer module can be synchronized to the rotation of the fluidic module. In examples, the rotations can also be synchronized by applying correction parameters to both rotations to compensate detected offset angles between the same.

In examples, a regulation is performed to obtain a synchronization of the rotation of the transfer module and the fluid module based on real-time data indicating the respective angular positions of the transfer opening and the fluid opening. Respective signals can be transmitted between respective sensors and components that form the control by using any suitable communication protocols. For example, a trigger signal can be transferred once per rotation of the second drive from the second drive to the control and a movement-stop signal can be transmitted from the control to the second drive, for example when a liquid transfer has been completed. A position signal indicating the angular position of the first drive (rotor) can be transmitted from the first drive to the control. Respective signals, on the one hand, to adjust the rotation frequency of the first drive and the second drive based on the signals originating from the sensors, and, on the other hand, to effect the synchronization, can be transmitted by the control to the first and second drives. Any suitable communication protocols and interfaces, such as UART (Universal Asynchronous Receiver/Transmitter), TCP/IP (Transmission Control Protocol/Internet Protocol), CAN (Controller Area Network) and/or MODBUS can be used for such communication.

By using examples of the present invention, substances or mixtures of substances in the form of liquids can be introduced into and/or be withdrawn from any location of a fluidic module under rotation in a low-loss or loss-free manner and in a precise manner. A procedure where fluidic module and transfer module are each set in rotation by using separate drives, wherein the rotations are synchronized, has so far not been known. Rather, for introducing substances or mixtures of substances it used to be common to either stop the rotation of the fluidic module or to introduce the substances or mixtures of substances already prior to starting the first rotation step. In particular, it was not obvious that it is possible to obtain a highly precise synchronization of the two circular paths which is also stable across a longer transfer period. Further, surprisingly, it has been found out that when using an electronic pipet, the pipet tip filled with liquid is not discharged in an uncontrolled manner, for example too early, under the action of centrifugal forces, but only after reaching a stable synchronization in response to an electronic actuating signal. Thus, according to examples of the invention, it is possible to effect the liquid transfer exactly after reaching the stable synchronization by electronic actuation of the pipet to obtain controlled discharge of the pipet into the fluid opening of the fluidic module and hence into fluidic structures of the fluidic module.

In examples of the invention, the fluid module can comprise several respective fluid openings and/or the transfer module can comprise several respective transfer openings. Thus, embodiments allow different liquids to be transferred simultaneously or at different times at different locations between transfer module and fluid module or vice versa. For example, the transfer module can comprise a number of dispenser heads, e.g., five integrated dispenser heads and can be rotated to transfer five different liquids at different times/locations into the fluid openings of the fluidic module.

Examples of the invention provide apparatuses and methods where a system for dispensing liquids is set into rotation to transport liquids into a second rotating fluidic system or to draw the same from the second rotating fluidic system. Here, dispensing the liquid can take place continuously as jet or discontinuously as drops, depending on the actuation of the transfer module. In examples, the offset of the trajectory on the free path between dispensing system (transfer module) and fluidic system (fluidic module) can be compensated. In examples, a robot arm according to the SCARA principle can be used for rotating the dispensing system. In examples, a circular movement of two computer-controlled linear axes resulting by superposition can be used for rotating the dispensing system. In examples, for rotating the dispensing system, a module with integrated rotating motor can be used. In examples, a system for dispensing liquid for supplying several rotating fluidic systems can be used, for example, in that the fluidic module comprises several fluidic collecting chambers with allocated fluid openings. In such systems, the second drive can be configured to position the transfer opening each relative to one of the several fluid openings and hold the same during the rotations, to allow liquid transfer between the respective fluid opening and the transfer opening. In such examples, the second drive can further be configured to change or adjust the radial position of the transfer opening with respect to the rotation axis.

Examples of the invention can be used in a plurality of fields. Examples can be used in automation of extraction protocols for isolating analytes, e.g., DNA of biological samples, e.g., blood plasma. Examples can be used in the automation of sample preparation protocols, for preparing analyses, e.g., next generation sequencing, for example DNA library preparation protocols. Examples can be used in automation of cell culture protocols, for example to add and/or withdraw media, for example in defined time periods as needed, and hence provide controlled conditions (online process control).

Examples of the invention offer numerous advantages compared to conventional methods. For example, the transfer of media into a fluid module is allowed under rotation and hence while maintaining the centrifugal forces in the fluidic module, wherein, for example, capillary wetting of channels or resuspension of previously sedimented substances or analytes can be prevented. Examples of the invention allow the shift of complexity from the consumable, the fluidic module, into the device and hence long-term cost savings. For example, functionalizations in the fluidic module or also the usage of flow bags can be prevented. By the inventive process, pre-storage in the consumable is no longer needed, which provides space on the fluidic module that can be used for realizing longer or more complex process chains or can be used for parallel processing of several samples in a fluidic module. Examples allow introducing very large liquid volumes in a range of several millimetres, which is not possible with common pre-storage techniques. Apart from that, examples also allow introducing very small liquid volumes in the range of several microliters, which is not possible with common pre-storage techniques. This is particularly advantageous in applications where cost-intensive reagents are used. Examples allow an electronic programmability of providing substances and mixtures of substances and hence the option of active control of a process (on-line process control). An electronically controlled provision of substances as it is performed in examples of the invention, allows a high process robustness as production-induced insecurities by sealed seams of the flow bags, wax valves and the same can be prevented. Further, examples of the invention also allow, apart from dispensing liquids from the transfer module into the fluidic module, withdrawing products from the fluidic module under rotation, whereby again, for example, capillary wetting of channels or resuspension of previously sedimented substances or analytes can be prevented.

Although features of the invention have been described, each based on apparatus features or method features, it is obvious for a person skilled in the art that respective features can also be part of a method or an apparatus. Thus, the apparatus can be configured to perform respective method steps and the respective functionality of the apparatus can represent respective method steps.

In the preceding detailed description, various features have been grouped together in examples in part to streamline the disclosure. This type of disclosure should not be interpreted as intending that the claimed examples have more features than are explicitly stated in each claim. Rather, as the following claims reflect, subject matter may be found in fewer than all of the features of a single disclosed example. Consequently, the following claims are hereby incorporated into the detailed description, and each claim may stand as its own separate example. While each claim may stand as its own separate example, it should be noted that although dependent claims in the claims refer back to a specific combination with one or more other claims, other examples also include a combination of dependent claims with the subject matter of any other dependent claim or a combination of any feature with other dependent or independent claims. Such combinations are encompassed unless it is stated that a specific combination is not intended. It is further intended that a combination of features of a claim with any other independent claim is also encompassed, even if that claim is not directly dependent on the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for transferring liquid between modules rotating around a rotation axis, comprising:
a fluidic module comprising a fluid opening oriented in a first direction and fluidically connected to fluidic structures in the fluidic module, wherein the first direction corresponds to a first axial direction with respect to the rotation axis or comprises an angle of <90° to the first axial direction;
a transfer module comprising a transfer opening oriented in a second direction, wherein the second direction corresponds to a second axial direction with respect to the rotation axis that is opposite to the first axial direction or comprises an angle of <90° to the second axial direction, wherein the transfer module is configured to dispense or receive liquid through the transfer opening;
a first drive configured to effect a rotation of the fluidic module to move the fluid opening along a circular path around the rotation axis;
a second drive configured to effect a rotation of the transfer module to move the transfer opening along a circular path around the rotation axis; and
a control configured to synchronize the rotation of the fluidic module and the rotation of the transfer module to position the fluid opening and the transfer opening relative to each other to allow liquid transfer between the transfer opening and the fluid opening during the rotations.

2. Apparatus according to claim 1, wherein the control is configured to control the transfer module to a dispense or receive liquid through the transfer opening, while the rotation of the fluidic module and the rotation of the transfer module are synchronized.

3. Apparatus according to claim 1, wherein the transfer module is configured to eject liquid in the first direction from the transfer opening continuously as jet or discontinuously as drops.

4. Apparatus according to claim 3, wherein, during the synchronous rotation, the fluid opening and transfer opening are positioned relative to each other in azimuthal direction with respect to the rotation axis to compensate an offset of the trajectory on the free path between the transfer opening and the fluid opening.

5. Apparatus according to claim 3, wherein, during the synchronous rotation, the liquid opening and transfer opening are positioned relative to each other in radial direction with respect to the rotation axis to compensate for centrifugal deflection of the liquid on the free path between the transfer opening and the fluid opening.

6. Apparatus according to claim 1, wherein the transfer module comprises an electronic pipet with a pipet tip, wherein the transfer opening is formed at the pipet tip.

7. Apparatus according to claim 6 comprising a maneuvering unit configured to move, during the synchronous rotation, the pipet tip in the first direction and/or the fluidic module in the second direction to dip the pipet tip into the fluid opening.

8. Apparatus according to claim 1, wherein the fluidic module comprises several fluid openings oriented in the first direction with respect to the rotation axis, wherein the control is configured to synchronize the rotation of the fluidic module and the rotation of the transfer module to position one of the several fluidic openings and the transfer opening relative to each other to successively allow liquid transfer between the transfer opening and the several fluid openings and/or wherein the transfer module comprises several transfer openings, wherein the control is configured to synchronize the rotation of the fluidic module and the rotation of the transfer module to position the several transfer openings and several fluid openings relative to each other to allow liquid transfer between the transfer openings and several fluid openings of the fluidic module.

9. Apparatus according to claim 1, wherein the radial position of the transfer opening can be adjusted.

10. Apparatus according to claim 1, wherein the second drive comprises a rotating motor, a robot arm comprising several axis or a linear axis system.

11. Apparatus according to claim 1, wherein the control is configured to control the first or second drive to effect a rotation of one of the fluidic module and the transfer module at a rotation frequency that corresponds to the rotation frequency of the other one of the fluidic module and the transfer module.

12. Apparatus according to claim 11, wherein the control is configured to detect an angular offset between the fluid opening and the transfer opening and to control the rotation of the fluidic module and/or the transfer module to bring the angular offset into a tolerance range.

13. Apparatus according to claim 12, wherein the control is configured to detect the angular offset at a time when one of the fluid opening and the transfer opening is located at a specific position along the respective circular path, based on a difference between an actual position of the other one of the fluid opening and the transfer opening and a target position.

14. Method for transferring liquid between modules rotating around a rotation axis, comprising:
effecting a rotation of a fluidic module comprising a fluid opening oriented in a first direction and fluidically connected to fluidic structures in the fluidic module to move the fluid opening along a circular path around the rotation axis, wherein the first direction corresponds to a first axial direction with respect to the rotation axis or comprises an angle of <90° to the first axial direction;
effecting a rotation of a transfer module comprising a transfer opening oriented in a second direction, wherein the second direction corresponds to a second axial direction with respect to the rotation axis that is opposite to the first axial direction or comprises an angle of <90° to the second axial direction, wherein the transfer module is configured to dispense or receive liquid through the transfer opening, to move the transfer opening along a circular path around the rotation axis;
synchronizing the rotation of the fluidic module and the rotation of the transfer module to position the fluid opening and the transfer opening relative to each other; and
effecting a liquid transfer between the transfer opening and the fluid opening during the rotations of the fluidic modules and the transfer modules.

15. Method according to claim 14, wherein, during the synchronous rotation of the fluidic module and the transfer module, the fluid opening and the transfer opening are positioned relative to each other in azimuthal direction with respect to the rotation axis to compensate an offset of the trajectory on the free path between transfer opening and fluid opening, and/or the fluid opening and the transfer opening are positioned relative to each other in radial direction with respect to the rotation axis to compensate a centrifugal deflection of the liquid on the free path between transfer opening and liquid opening.

16. Method according to claim 14, wherein the transfer module comprises an electronic pipet with a pipet tip, wherein the transfer opening is formed at the pipet tip and wherein the method comprises moving the pipet tip in the first direction and/or the fluidic module in the second direction during the synchronous rotation to dip the pipet tip into the fluid opening.

17. Method according to claim 14, further comprising adjusting a radial position of the transfer openings to successively effect liquid transfer between the transfer opening and several fluid openings formed in the fluidic module while the rotations of the fluidic module and the transfer module are synchronized with each other.

18. Method according to claim 14, wherein the rotations of the fluidic module and the rotation of the transfer module are synchronized such that one of several fluid openings of the fluidic module and the transfer opening or one of several transfer openings of the transfer module are positioned relative to each other and liquid transfer between the transfer opening or the transfer openings and several fluid openings is effected successively or simultaneously.

19. Method according to claim 14, wherein synchronizing the rotations comprises:
rotating the fluidic module and rotating the transfer module at the same rotation frequency;
detecting an angular offset between the fluid opening and the transfer opening; and
controlling the rotation of the fluidic module and/or the transfer module to bring the angular offset into a tolerance range.

20. Method according to claim 19, wherein detecting the angular offset comprises:
detecting that one of the fluid opening and the transfer opening is located at a specific angular position along the respective circular path;
detecting the angular position of the other one of the fluid opening and the transfer opening when the one of the fluid opening and the transfer opening is located at the predetermined angular position;
determining the angular offset based on a difference between the detected angular position of the other one of the fluid opening and the transfer opening and a target position.
